(19) United States
(12) Patent Application Publication
(10) Pub. No.: US 2014/0100962 A1
(43) Pub. Date: Apr. 10, 2014

(54) METHODS, SYSTEMS, AND COMPUTER READABLE MEDIA FOR AD-SUPPORTED WIRELESS OFFLOADING

(71) Applicant: Tekelec, Inc., Morrisville, NC (US)

(72) Inventors: Sundaram Rajagopalan, Waltham (IN); Ajay Padmakar Deo, Carrollton (IN); Michael Craig Heffner, Holly Springs, NC (US)

(73) Assignee: Tekelec, Inc., Morrisville, NC (US)

(21) Appl. No.: 14/051,119

(22) Filed: Oct. 10, 2013

Related U.S. Application Data
(60) Provisional application No. 61/712,225, filed on Oct. 10, 2012.

(51) Int. Cl. H04W 4/20

(52) U.S. Cl. CPC H04W 4/206
USPC 705/14.64

(57) ABSTRACT

Methods, systems, and computer readable media for advertisement-supported wireless offloading are disclosed. According to one aspect, a system for advertisement-supported wireless offloading includes an offload controller for controlling mobile device offloading, the controller including a network interface for sending and receiving messages in a telecommunications network and a control module for detecting a subscriber offload request, causing an advertisement to be sent to the subscriber's mobile device, determining whether the subscriber did or did not accept the advertisement, and providing a response to the offload request based on whether the subscriber did or did not accept the advertisement.

### PRIORITY CLAIM

This application claims the benefit of U.S. Provisional Patent Application Ser. No. 61/712,225, filed Oct. 10, 2012; the disclosure of which is incorporated herein by reference in its entirety.

### TECHNICAL FIELD

The subject matter described herein relates to methods and systems for providing targeted advertisements (“ads”) to mobile devices. More particularly, the subject matter described herein relates to methods, systems, and computer readable media for advertisement-supported wireless offloading.

### BACKGROUND

The data deluge in the mobile network, along with the loss in average revenue per user (ARPU) owing to the fall in popularity of the operator-owned services such as voice service, has caused many operators to rethink their business model and try and monetize the mobile network with targeted ads. However, effective targeting of these advertisements requires very specific information about the subscriber device and the user's data patterns, quota usage etc. This information is hard to procure for many infrastructure vendors in the mobile network either owing to the prohibitive cost of mining for such information (not all vendor infrastructure has access to this information), or because subscriber-level information is difficult to procure. Another problem is that subscriber profiling is only feasible in the signaling plane and on infrastructure that is not directly in the user data path. Because of this, typical vendor infrastructure devices that can mine subscriber information cannot insert the advertisement once a subscriber is profiled.

Therefore, there exists a need for techniques to push advertisements to a mobile device. An attractive option for operators of cellular networks, for example, is to subsidize the access to a particular type of wireless network access using an advertisement-supported model. Accordingly, there is a need for methods, systems, and computer readable media for advertisement-supported wireless offloading.

### SUMMARY

According to one aspect, a system for advertisement-supported wireless offloading includes an offload controller for controlling mobile device offloading, the controller including a network interface for sending and receiving messages in a telecommunications network and a control module for detecting a subscriber offload request, causing an advertisement to be sent to the subscriber's mobile device, determining whether the subscriber did or did not accept the advertisement, and providing a response to the offload request based on whether the subscriber did or did not accept the advertisement.

According to another aspect, the subject matter described herein includes a method for advertisement-supported wireless offloading. The method includes detecting, at an offload controller for controlling mobile device offloading and having a hardware processor, a subscriber offload request, and in response to detecting the subscriber offload request, causing an advertisement to be sent to the subscriber's mobile device, determining whether the subscriber did or did not accept the advertisement, and providing a response to the offload request based on whether the subscriber did or did not accept the advertisement.

As used herein, the term “wireless” refers to wireless data networks that use radio waves to provide high-speed internet and network connections. Examples of wireless data networks include, but are not limited to, Wi-Fi, WiMAX, 3GPP2, 3GPP Release 7 and earlier, 3GPP Release 8 and later.

The subject matter described herein can be implemented in software in combination with hardware and/or firmware. For example, the subject matter described herein can be implemented in software executed by a processor. In one exemplary implementation, the subject matter described herein can be implemented using a non-transitory computer readable medium having stored thereon computer executable instructions that when executed by the processor of a computer control the computer to perform steps. Exemplary computer readable media suitable for implementing the subject matter described herein include non-transitory computer-readable media, such as disk memory devices, chip memory devices, programmable logic devices, and application specific integrated circuits. In addition, a computer readable medium that implements the subject matter described herein may be located on a single device or computing platform or may be distributed across multiple devices or computing platforms.

### BRIEF DESCRIPTION OF THE DRAWINGS

Preferred embodiments of the subject matter described herein will now be explained with reference to the accompanying drawings, wherein like reference numerals represent like parts, of which:

FIG. 1 is a block diagram illustrating an exemplary system for advertisement-supported Wi-Fi offloading according to an embodiment of the subject matter described herein;

FIG. 2 is a flow chart illustrating an exemplary process for advertisement-supported Wi-Fi offloading according to another embodiment of the subject matter described herein;

FIG. 3 is an exemplary message flow diagram illustrating signaling messages exchanged during a process for advertisement-supported Wi-Fi offloading according to yet another embodiment of the subject matter described herein;

FIG. 4 is an exemplary message flow diagram illustrating signaling messages exchanged during a process for advertisement-supported Wi-Fi offloading according to yet another embodiment of the subject matter described herein; and

FIG. 5 is an exemplary message flow diagram illustrating signaling messages exchanged during a process for advertisement-supported Wi-Fi offloading according to yet another embodiment of the subject matter described herein.

### DETAILED DESCRIPTION

In accordance with the subject matter disclosed herein, methods, systems, and computer readable media for advertisement-supported wireless offloading are provided. The subject matter described herein allows a mobile device to roam into a geographical area with a particular type of wireless access, e.g., Wi-Fi, via an Access Point (AP), request the mobile network for information for connecting to the wireless access network (in this case, the Wi-Fi credentials for the AP), and then wait for the mobile advertisement message from the network. Once the targeted advertisement is received by the mobile device, the mobile device will be offloaded to the wireless network. The methods and systems described herein allow the operator to tie Wi-Fi and other types of wireless access to an advertisement-supported model. This in turn helps the operator monetize wireless access, and subsidize the management and provisioning of operator-owned wireless access, as well as offload the mobile network.

Reference will now be made in detail to exemplary embodiments of the present invention, examples of which are illustrated in the accompanying drawings. Wherever possible, the same reference numbers will be used throughout the drawings to refer to the same or like parts.

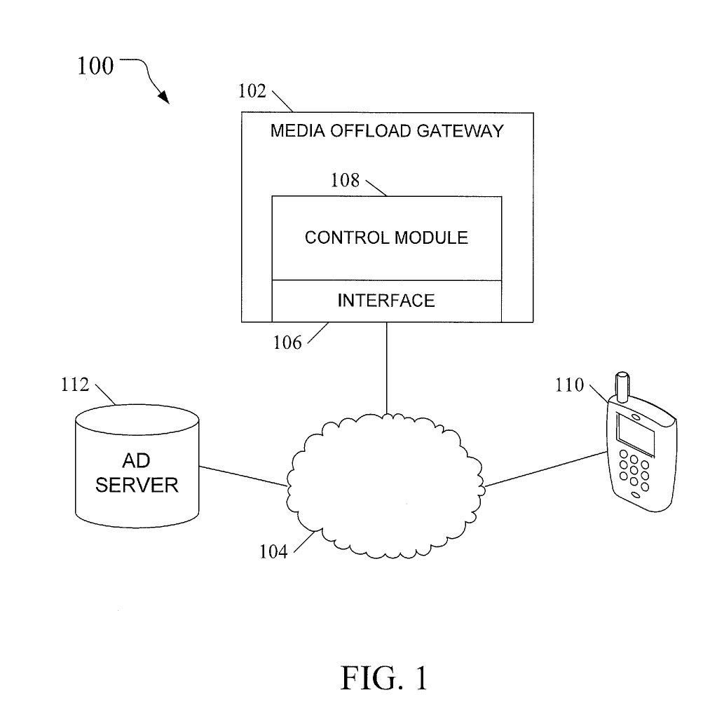

FIG. 1 is a block diagram illustrating an exemplary system for advertisement-supported wireless offloading according to an embodiment of the subject matter described herein. In the embodiment illustrated in FIG. 1, system 100 includes an offload controller 102 for controlling mobile device offloading in a telecommunications network 104. In one embodiment, offload controller 102 comprises a mobile offload gateway or other operator network infrastructure device that controls when and what type of wireless network a mobile device may offload to.

Offload controller 102 includes a network interface 106 for sending and receiving messages to and from network 104 and a control module 108 for detecting a subscriber offload request, causing an advertisement to be sent to the subscriber's mobile device, such as mobile telephone 110, and determining whether the subscriber did or did not accept the advertisement, and providing a response to the offload request based on whether the subscriber did or did not accept the advertisement.

“Accepting the advertisement” may include viewing the advertisement or allowing the advertisement to be displayed to the subscriber via the subscriber device's display (e.g., if the advertisement is text, an image, or a video); allowing the advertisement to be played to the subscriber via the subscriber device's speaker (e.g., if the advertisement contains sound); or allowing the advertisement to be loaded onto or executed by the subscriber device (e.g., if the advertisement is an app, is an applet, or otherwise contains executable code.) “Not accepting the advertisement” may include blocking or prohibiting any of the above.

In one embodiment, offload controller 102 may receive a request that came from subscriber device 110 or that was sent by another network entity on behalf of subscriber device 110. Examples of offload requests include, but are not limited to, requests to transfer from a cellular network onto a Wi-Fi network or other wireless data network.

In one embodiment, offload controller 102 may push or otherwise send the advertisement to subscriber device 110 directly, and in another embodiment, offload controller 102 may instruct another node, such as an advertisement server (ADSVR) 112, to send the ad to subscriber device 110. Likewise, offload controller 102 may receive notification of the subscriber's response directly from subscriber device 110, from advertisement server 112, or through some other means.

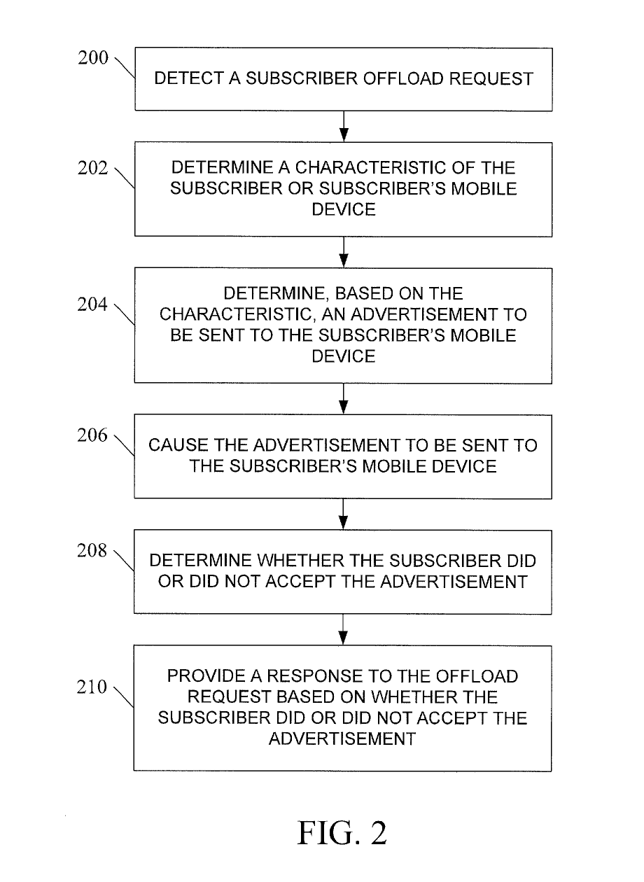

There are a number of response that offload controller 102 may provide to the offload request based on whether or not the subscriber allowed (e.g., viewed) or denied (e.g., did not view) the advertisement. For example, in one embodiment, offload controller 102 may allow the offload request if the subscriber accepted the ad and deny the offload request if the subscriber did not accept the ad. Alternatively, offload controller 102 may allow the offload request regardless of the subscriber's response but give the subscriber a high quality of service (QoS) if the subscriber accepted the ad and a low QoS if the subscriber did not accept the ad. In yet another alternative, a subscriber that accepts an ad may be allowed to join a fast wireless network while a subscriber that rejects an ad may be allowed to join only a slower wireless network. Exemplary operation of the system illustrated in FIG. 1 will not be described with reference to FIGS. 2 through 5.

FIG. 2 is a flow chart illustrating an exemplary process for advertisement-supported wireless offloading according to another embodiment of the subject matter described herein. In the embodiment illustrated in FIG. 2, a method for advertisement-supported wireless includes, at step 200, detecting, at an offload controller for controlling mobile device offloading and having a hardware processor, a subscriber offload request. Referring to the system illustrated in FIG. 1, for example, subscriber device 110 currently operating in the cellular telecommunications network 104 may send a sync request to offload from cellular network 104 to a wireless network not shown in FIG. 1, This request may be received by offload controller 102. The offload request may be sent by subscriber device 110 or by another node on behalf of subscriber device 110.

In the embodiment illustrated in FIG. 2, the method includes determining a characteristic of the subscriber or subscriber's mobile device (step 202) and determining an advertisement to be sent to the subscriber's mobile device based on the determined characteristic (step 204). In one embodiment, offload controller 102 may determine a characteristic of a subscriber by requesting subscriber profile information. For example, offload controller 102 may get information about the subscriber and/or the subscriber's relationship to the mobile device connecting to the network by querying a home subscriber server (HSS), a home location register (HLR), a subscriber profile repository (SPR), or operator network infrastructure element that determine the profile and characteristics of the connected subscriber. A characteristic of a subscriber or a subscriber's mobile device may include, but is not limited to, profile information for the subscriber, the subscriber's relationship to the mobile device, a geographic location of the subscriber, information associated with a cell to which the mobile device is currently connected, a capability of the mobile device, and an identity of an offload target.

In one embodiment, offload controller 102 may use this information to identify which subscribers are connected via what Access Points (AP), and correlating this with other mobile device activity in the network such as geographic location of the access being requested by the mobile device, currently connected cell information of the mobile device, time of access, etc. Offload controller 102 may use the information stated above, and may enrich it with any other subscriber, location, device, application, and time of access information that is collected as part of ascertaining the subscriber policies for the offload for generating advertisement/campaign profile for the subscriber.

In one embodiment, offload controller 102 may determine an appropriate format for the advertisement, depending on the subscriber's profile, current quality of service, and capabilities of the subscriber's mobile device. For example, if the subscriber's mobile device only supports text messages, the advertisement may be in the form of an SMS message. Likewise, if the subscriber's mobile device supports email, the advertisement may be sent by email. The advertisement may also be audio .only, video only, multimedia, or an application or applet, depending on the capabilities of the subscriber device, the subscriber's level or tier of service, subscriber preferences, etc.

In one embodiment, offload controller 102 may determine an appropriate advertising subject based on a variety of information including, but not limited to, customer profile information, customer geographic location and/or proximity to advertisers' stores, or other information that may be used to tailor an advertisement to a particular subscriber or class of subscribers.

Step 206 includes causing an advertisement to be sent to the subscriber's mobile device. Ads may be sent to subscriber device 110 using well known methods for pushing/adapting Internet Protocol (IP) based content. In one embodiment, offload controller 102 may send the advertisement to subscriber device 110. In another embodiment, offload controller 102 may send a request or an instruction to a node other than subscriber device 102, such as advertisement server 112 or other infrastructure nodes in the operator network that are responsible for the collection and storage of video and text-based advertisements that are pushed to the mobile device. Network operators may use such devices to manage advertisement campaigns with product marketers. Advertisement server 112 may respond to the request or instruction by sending the ad to subscriber device 110.

Step 208 includes determining whether the subscriber did or did not accept the advertisement. Accepting the advertisement may mean simply viewing or listening to the advertisement as it is played. It may also mean agreeing to receive future advertisements.

In one embodiment, this indication may come from the subscriber device itself. For example, subscriber device 110 may include software that is capable of receiving the mobile advertisement from the operator network, presenting the advertisement to the subscriber, giving the subscriber the option to accept or not accept the advertisement, and reporting the subscriber's choice directly or indirectly to offload controller 102.

In another embodiment, offload controller 102 or another node may determine whether the subscriber did or did not accept the advertisement based on network signaling or data traffic. For example, subscriber device 110 may receive and advertisement that includes a URL or link to a website and a request that the subscriber visit that URL. If the subscriber visits that URL, this creates network traffic to and from that URL, which can be detected and used as evidence that the subscriber accepted the advertisement. This network traffic may be detected by offload controller 102 directly or by another node, which notifies offload controller 102.

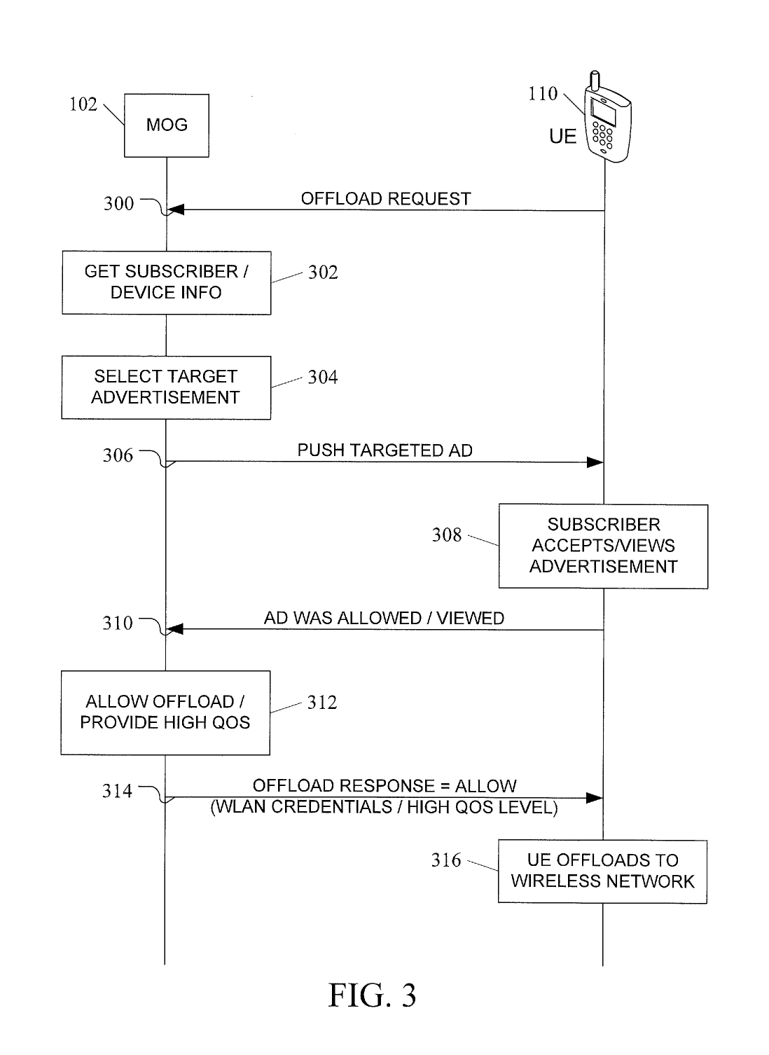

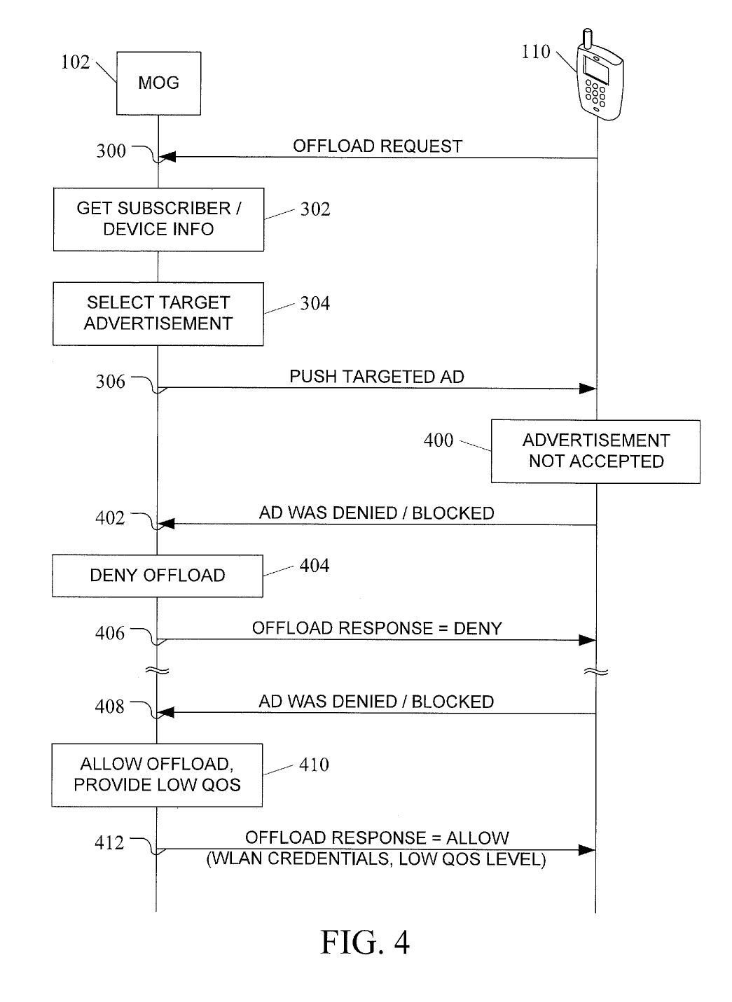

Step 210 includes providing a response to the offload request based on whether the subscriber did or did not accept the advertisement. As will be shown in FIGS. 3 and 4 below, an operator can respond to a subscriber that accepts or does not accept an advertisement in a number of ways, including, but not limited to, allowing the offload if the ad is accepted and denying the offload is the ad is not accepted; allowing the offload and providing a high QoS level if the ad is accepted and allowing the offload but providing a low QoS level if the ad is not accepted; an allowing the offload to a fast/low latency/uncongested network if the ad is accepted and allowing the offload to a slow/high latency/congested network if the ad is not accepted.

FIG. 3 is an exemplary message flow diagram illustrating signaling messages exchanged during a process for advertisement-supported wireless offloading according to yet another embodiment of the subject matter described herein. FIG. 3 shows an example interaction in which the subscriber accepts the advertisement. In the scenario illustrated in FIG. 3, an offload controller, which in this example is a media offload gateway (MOG) 102, receives an offload request 300 directly from a subscriber device 110.

In the embodiment illustrated in FIG. 3, MOG 102 responds to this offload request by getting subscriber and/or device information (block 302) e.g., using the methods described above. In alternative embodiments, however, MOG 102 may skip this step, because MOG 102 may already have this information from a previous interaction with subscriber device 110, for example, or because the network operator sends an advertisement regardless of the particulars of the subscriber and/or the subscriber's device and thus does not need to get this information.

In the embodiment illustrated in FIG. 3, MOG 102 selects a target advertisement (block 304) and pushes the targeted ad (message 306) to subscriber device 110. At block 308, the subscriber accepts (e.g., views) the advertisement, and MOG 102 receives notification of this (message 310.) In response to acceptance of the advertisement by the subscriber, MOG 102 allows the offload (block 312) and provides a high QoS to subscriber device 110. MOG 102 sends a response (message 314) to subscriber device 110, allowing the offload and providing the necessary WLAN credentials, which subscriber device then uses to offload to the identified WLAN (block 316.)

FIG. 4 is an exemplary message flow diagram illustrating signaling messages exchanged during a process for advertisement-supported wireless offloading according to yet another embodiment of the subject matter described herein. FIG. 4 shows an example interaction in which the subscriber does not accept the advertisement. In the scenario illustrated in FIG. 4, an offload controller, which in this example is a media offload gateway (MOG) 102, receives an offload request 300, gets subscriber and/or device information (block 302), selects a target advertisement (block 304) and pushes the targeted ad (message 306) to subscriber device 110. These steps are essentially identical their like-numbered counterparts in FIG. 3.

In the embodiment illustrated in FIG. 4, however, the subscriber does not accept the advertisement (block 400.) MOG 102 receives notification of this (message 402.)

In one embodiment, MOG 102 may respond to the rejection of the advertisement by denying the offload (block 404) and sending a deny response (message 406) to subscriber device 110.

In another embodiment, MOG 102 may respond to the rejection of the advertisement by allowing the offload, but providing a low or “best effort” QoS to the subscriber (block 410) and sending the needed information (WLAN credentials, QoS level) to subscriber device 110, which then offloads accordingly (not shown.)

In yet another embodiment, MOG 102 may respond to an acceptance of the advertisement by allowing offload to a first wireless network and respond to a rejection of the advertisement by allowing offload to a second wireless network that is slower, more congested, or otherwise less capable than the first wireless network.

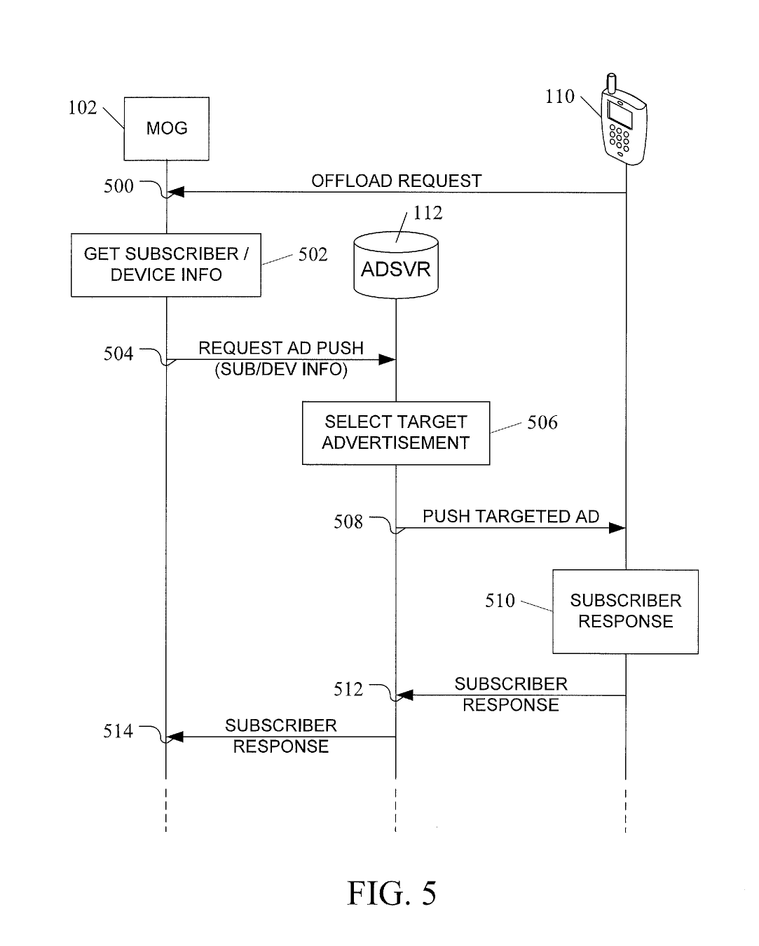

FIG. 5 is an exemplary message flow diagram illustrating signaling messages exchanged during a process for advertisement-supported wireless offloading according to yet another embodiment of the subject matter described herein. FIG. 5 shows an example interaction in which an advertisement server 112 is engaged to supply the targeted ad to subscriber device 110. In the embodiment illustrated in FIG. 5, an offload controller MOG 102 receives n offload request (message 500) from a subscriber device 110. In response to receiving the offload request message 500, MOG 102 gets information about the subscriber and/or subscriber's device (step 502), and sends a request (message 504) to advertisement server (ADSVR) 112.

In one embodiment, the request includes information about the subscriber and/or subscriber's device, and at block 506, ADSVR 112 uses this information to select a target advertisement 506. In an alternative embodiment, MOG 102 may select the target advertisement and indicate the selected advertisement as part of request message 504.

ADSVR 112 then sends the targeted ad to subscriber device 110. In the embodiment illustrated in FIG. 5, this is a push message 508. The subscriber responds to the push message, e.g., allows or does not allow the advertisement. In the embodiment illustrated in FIG. 5, ADSVR 112 directly or indirectly receives notification of that choice (message 512), and forwards that information to MOG 102 (message 514.) MOG 102 may receive notification directly from subscriber device 110 or indirectly from a node other than ADSVR 112 or subscriber device 110.

It will be understood that various details of the subject matter described herein may be changed without departing from the scope of the subject matter described herein. Furthermore, the foregoing description is for the purpose of illustration only, and not for the purpose of limitation.

What is claimed is:

1. A system for advertisement-supported wireless offloading comprises:
an offload controller for controlling mobile device offloading, comprising:
a network interface for sending and receiving messages in a telecommunications network; and
a control module for detecting a subscriber offload request, causing an advertisement to be sent to the subscriber's mobile device, determining whether the subscriber did or did not accept the advertisement, and providing a response to the offload request based on whether the subscriber did or did not accept the advertisement.

2. The system of claim 1 wherein detecting a subscriber offload request comprises receiving an offload request from the subscriber's mobile device.

3. The system of claim 1 wherein causing an advertisement to be sent to the subscriber's mobile device comprises sending the advertisement to the subscriber's mobile device.

4. The system of claim 1 wherein causing an advertisement to be sent to the subscriber's mobile device comprises causing the advertisement to be sent to the subscriber's mobile device by an advertisement server separate from the offload controller.

5. The system of claim 1 wherein determining whether the subscriber did or did not accept the advertisement comprises receiving an indication that the subscriber did or did not accept the advertisement from subscriber's mobile device.

6. The system of claim 1 wherein providing a response to the offload request based on whether the subscriber did or did not accept the advertisement comprises one of:
allowing or denying the offload request; and
providing a first or second quality of service;
based on whether the subscriber did or did not accept the advertisement.

7. The system of claim 1 wherein the offload controller comprises a mobile offload gateway.

8. The system of claim 1 wherein the offload controller controls access to a wireless network comprising at least one of:
a Wi-Fi network;
a WiMAX network; and
a 3GPP network.

9. A method for advertisement-supported wireless offloading comprises:
detecting, at an offload controller for controlling mobile device offloading and having a hardware processor, a subscriber offload request; and
in response to detecting the subscriber offload request:
causing an advertisement to be sent to the subscriber's mobile device;
determining whether the subscriber did or did not accept the advertisement; and
providing a response to the offload request based on whether the subscriber did or did not accept the advertisement.

10. The method of claim 9 wherein detecting a subscriber offload request comprises receiving an offload request from the subscriber's mobile device.

11. The method of claim 9 wherein causing the advertisement to be sent to the subscriber's mobile device comprises determining a characteristic of the subscriber or the subscriber's mobile device and determining an advertisement to be sent to the subscriber based on the determined characteristic.

12. The method of claim 11 wherein determining a characteristic of the subscriber or the subscriber's mobile device comprises determining at least one of:
profile information for the subscriber;
the subscriber's relationship to the mobile device;
a geographic location of the access being requested by the mobile device;
information associated with a cell to which the mobile device is currently connected; and
an identity of an offload target.

13. The method of claim 9 wherein causing an advertisement to be sent to the subscriber's mobile device comprises sending the advertisement to the subscriber's mobile device.

14. The method of claim 9 wherein causing an advertisement to be sent to the subscriber's mobile device comprises causing the advertisement to be sent to the subscriber's mobile device by an advertisement server separate from the offload controller.

15. The method of claim 9 wherein the advertisement that is sent to the subscriber's mobile device comprises a video or text-based advertisement.

16. The method of claim 9 wherein determining whether the subscriber did or did not accept the advertisement comprises receiving an indication that the subscriber did or did not accept the advertisement from the subscriber's mobile device.

17. The method of claim 16 wherein receiving the indication from the subscriber's mobile device comprises receiving the indication from software on the subscriber's mobile device that receives the mobile advertisement from the operator network, presents the advertisement to the subscriber, gives the subscriber the option to accept or not accept the advertisement, and reports the subscriber's choice.

18. The method of claim 9 wherein providing a response to the offload request based on whether the subscriber did or did not accept the advertisement comprises one of:
allowing or denying the offload request; and
providing a first or second quality of service;
based on whether the subscriber did or did not accept the advertisement.

19. A non-transitory computer readable medium having stored thereon executable instructions that when executed by the processor of a computer control the computer to perform steps comprising:
detecting a subscriber offload request, and, in response to detecting the subscriber offload request:
causing an advertisement to be sent to the subscriber's mobile device;
determining whether the subscriber did or did not accept the advertisement; and
providing a response to the offload request based on whether the subscriber did or did not accept the advertisement.
